(19) United States
(12) Patent Application Publication
(10) Pub. No.: US 2008/0128496 A1
(43) Pub. Date: Jun. 5, 2008

(54) METHOD AND APPARATUS FOR VERIFICATION OF ITEMS

(76) Inventors: Patrick Bertranou, Beverly Hills, CA (US); Gregoire Charillon, Beverly Hills, CA (US)

Correspondence Address: STEVEN VOSEN, 1563 SOLANO AVENUE #206, BERKELEY, CA, 94707, US

(21) Appl. No.: 11/743,867

(22) Filed: May 3, 2007

Related U.S. Application Data
(60) Provisional application No. 60/868,292, filed on Dec. 1, 2006.

(51) Int. Cl. G06K 19/06

(52) U.S. Cl. 235/383

(57) ABSTRACT

A method and apparatus are disclosed for verification of the authenticity of items identified with a three dimensional label. In one embodiment, a verification system includes a database of authentic label and item information, and permits a user to access the database to verify the authenticity of the label with the labeled items. In one embodiment, a user provides the database with a label code and the database then provides the user with label and item information corresponding to the authentic item.

### CROSS-REFERENCE TO RELATED APPLICATIONS

This application claims the benefit of U.S. Provisional Application No. 60/868,292 filed Dec. 1, 2006, the entire contents of which are hereby incorporated by reference herein and made part of this specification.

### BACKGROUND OF THE INVENTION

1. Field of the Invention

The present invention generally relates to methods and apparatus for item verification.

2. Discussion of the Background

The counterfeiting of goods is a world-wide problem. The original manufacturers or licensers of the goods that are counterfeited loose income and control of their market. Thus for example, the marketplace may become flooded with goods, diminishing the desirability of hard to get items, while counterfeited goods of inferior quality may reflect poorly on the original goods.

Another problem facing the manufacturers or licensers of goods is “diversion”—the diversion of authentic goods into an unauthorized market. For example, a manufacturer that intends to sell goods only through a high end market will not want to see its products sold in large retail stores, as the exclusivity and the brand name will be discounted by such sale.

It is difficult for many people, including consumers and government officials, to identify counterfeited goods or to determine the origin or source of authentic goods. It is also difficult for manufacturers to trace the origin of diverted products. Labels printed with standard techniques are easily reproduced, and thus do not provide an adequate solution to this problem. One solution that is being used is to provide the goods with labels that are easily identifiable and difficult to reproduce. Thus, for example, holographic labels, which are difficult and expensive to counterfeit, are inserted on packages of software.

There exists a need, in numerous industries, for techniques that permit the verification of products. Verification permits a recipient of the product to be certain of the origin and authenticity of the product, and, in some circumstances, the quality of the product or a user's safety in using the product. Such a technique should enable the consumer to obtain a positive identification of the product, should make it more difficult for counterfeiters of products, and may make it more difficult for the products to be diverted from their intended destination.

Thus there is a need in the art for methods and apparatus that permit for the identification of goods. Such methods and apparatus should be inexpensive to implement and easily verifiable.

### BRIEF SUMMARY OF THE INVENTION

Embodiments described herein overcome the disadvantages of the prior art by providing methods of verifying the authenticity or origin of labeled items. As one example, which is not meant to limit the scope of the present invention, products are provided with labels that each have different features. In one embodiment, the features are identifiable by a person. In another embodiment, the features are identifiable by a machine. In yet another embodiment, the features are randomly generated. In one embodiment, the features are selected from many features such that no two features are the same. In another embodiment, a database is compiled that includes at least one unique identifier of each label and identifiers of the product to which is attached. The database is provided to those wishing to authenticate the labeled items.

In one embodiment, a labeled item may be verified by a user having access to a verification system that includes labeled item information including, but not limited to, a unique human or machine readable label portion and a unique visually identifiable label portion. A user sends the label code to the verification system. The verification system determines which label feature image is associated with the label code, and provides an image of the label feature to the user. The user then compares the label feature on the labeled item with the image of the label feature provided by verification system and may determine if the item is authentic. Alternatively, the verification system includes item information corresponding to each label code, and verification system also provides the user with item information to facilitation identification.

Certain embodiments provide a method of item verification comprising providing two or more labels each having unique label information. In one embodiment, the label information includes a code and a feature. In another embodiment, the method further includes charging for the service of providing the two or more labels.

In one embodiment, the method of item verification further includes storing label information and item information associated with each label. In another embodiment, the method further includes accepting an item code and providing stored item information associated with the item code. In yet another embodiment, the method further includes not charging for the accepting an item code or providing stored item information. In one embodiment, the step of accepting includes accepting over a computer network, and the step of providing includes providing over a computer network.

In one embodiment, the method of item verification further includes storing label information and item information associated with each label. In another embodiment, the method further includes accepting an item code, and providing stored label feature information associated with the item code. In one embodiment, the label feature information is an image of the label feature. In another embodiment, the step of accepting includes accepting over a computer network, and the step of providing includes providing over a computer network.

Certain embodiments provide a method of item verification comprising providing two or more labels each having unique label information. In one embodiment, the label information includes a human-readable code including one or more alphanumeric characters. In another embodiment, the code is a machine-readable code.

Certain embodiments provide a method of providing item verification services for items associated with one of a plurality of labels, where each of the plurality of labels includes a label code and a label feature. The method includes accepting a code corresponding to the label code of one of the plurality of labels, where the accepted code has associated information; and providing the associated information. In one embodiment, the step of accepting includes accepting over a computer network. In another embodiment, the code is a human-readable code including one or more alphanumeric characters. In yet another embodiment, the code is a machine-readable code.

Certain embodiments include a method of verifying the authenticity of an item associated with a label, where the label is one of a plurality of labels each having a code and a label feature, and is associated with an authentic item. The method includes: accepting a code of a labeled item; determining information corresponding to an authentic item, where the information includes information related to the label feature and item information corresponding to the code of the labeled item; and providing the information.

Other embodiments include a code which is a digital representation of a readable code that may be, but is not limited to, a human readable code and/or a machine readable code. In certain other embodiments, the information related to the label feature is an image of at least a portion of the label. The label feature may further include, but is not limited to, a random or pseudo-random pattern.

Yet other certain embodiment include item information that may include, but is not limited to, a textual description of the item and/or at least one image of the item.

Certain embodiments of the method include accepting a payment for providing information. The payee may be, but is not limited to, the item distributor or item manufacturer.

Other certain embodiments of the method include assembling a plurality of codes and corresponding label features and item information.

Yet other embodiments of the method further include providing at least one of the plurality of labels.

Certain embodiments include a system for verifying the authenticity of items, where the system includes a computer system programmed to: accept a code from the user; compare the accepted code to a plurality of codes each having corresponding information including item information and label feature information; and provide the corresponding information to the user.

Other certain embodiments include a system where the code is a digital representation of a human readable code which may be, but is not limited to, one or more alphanumeric characters, and/or a machine readable code.

Yet other certain embodiments include a system that the code over a computer network, and provides the information over a computer network.

Certain embodiments include a system where the label feature information is an image of a label feature which may be, but is not limited to, a random or pseudo-random pattern.

Other certain embodiments include a system where the item information includes a textual description of the item and/or at least one image of the item.

Advantages of certain embodiments include, but are not limited to, preservation of the value of products having a limited quantity, traceability of items to avoid diversion to unintended markets, and the formation of direct and targeted consumer database for product development, sales or targeted advertising.

These features together with the various ancillary provisions and features which will become apparent to those skilled in the art from the following detailed description, are attained by the label of the present invention, preferred embodiments thereof being shown with reference to the accompanying drawings, by way of example only, wherein:

### BRIEF DESCRIPTION OF THE SEVERAL VIEWS OF THE DRAWING

FIG. 1 a schematic of one embodiment of a verification system that may be used to verify the authenticity of labeled items;

FIG. 2 is a flowchart illustrating one embodiment of a method of using the system of FIG. 1 for verifying items;

FIG. 3 is a flowchart of another embodiment of a method for verifying products;

FIG. 4 is a block diagram illustrating another embodiment of a method of verifying items;

FIG. 5 is a top view of one embodiment of a label;

FIG. 6 is a side view of the label of FIG. 5;

FIG. 7A is a top view of a first human readable label code;

FIG. 7B is a top view of a second machine readable label code;

FIGS. 8A-8E are side views of one embodiment of a manufacturing process of a one embodiment of a label, where FIG. 8A is a first step, FIG. 8B is a second step, FIG. 8C is a third step, FIG. 8D is a fourth step, and FIG. 8E is a fifth step;

FIGS. 9A-9C are schematic illustrations of top views of different label features formed by different applications of the methods of FIG. 8A-8D, where FIG. 9A is a first label feature, FIG. 9B is a second label feature, and FIG. 9C is a third label feature;

FIG. 10 is a top view of a second embodiment of a label; and

FIG. 11 is a side view of the label of FIG. 10;

Reference symbols are used in the Figures to indicate certain components, aspects or features shown therein, with reference symbols common to more than one Figure indicating like components, aspects or features shown therein.

### DETAILED DESCRIPTION OF THE INVENTION

Certain embodiments of the present invention are directed to the verification of the authenticity of label items. The term “item” is used herein, without limitation, to refer to any item to be authenticated. Examples of such items include, but are not limited to, consumer, commercial, industrial, medical goods, automotive parts, or documents. In some embodiments, two or more of the items labeled are substantially identical items, including but not limited to otherwise identical manufactured consumer items. In other embodiments, the items labeled differ from one another, including but not limited to unique documents. For purposes of illustrating certain embodiments, for example, a person or company wishes to verify that a labeled item is authentic—that is, that it is an “authentic item.”

Certain embodiments include a verification system to enable a user to determine if labeled items are authentic. Thus, for example, the verification system facilitates the determination of whether or not the labeled item is an authentic item. The verification system includes, for example, a listing of label and corresponding authentic item information, referred to herein, and without limitation, as a “label-item database.” The terms “label-item database,” and “database” as used herein refer to one or more collections of information, in one or more electronic or printed formats, that can be used by a person and/or computer system to accept certain label information and provide corresponding label and/or item information for authentic items. In one embodiment, the recipient of a labeled item uses the verification system to obtain information from the label-item database that can be used to verify the authenticity of the item. Information within the label-item database may include, but is not limited to, alphanumeric strings representative of label codes, descriptions of items, or computer files that may be displayed as images of label features.

In an example, which is not meant to limit the scope of the present invention, each label has one or more codes or features that differ from each of the other labels, and is thus a “unique label” having “unique label information.” Thus, for example and without limitation, each label has a different code and a different visually identifiable feature, which, when placed on an item, uniquely identifies the labeled item. In one embodiment, the association between the code and feature is not readily apparent, and is maintained by an authentication service provider in the label-item database. The authentication service provider may, for example, accept a code from an item holder and provide information for authenticating the associated feature, such as an image of the feature. The database operator may also provide associated item information.

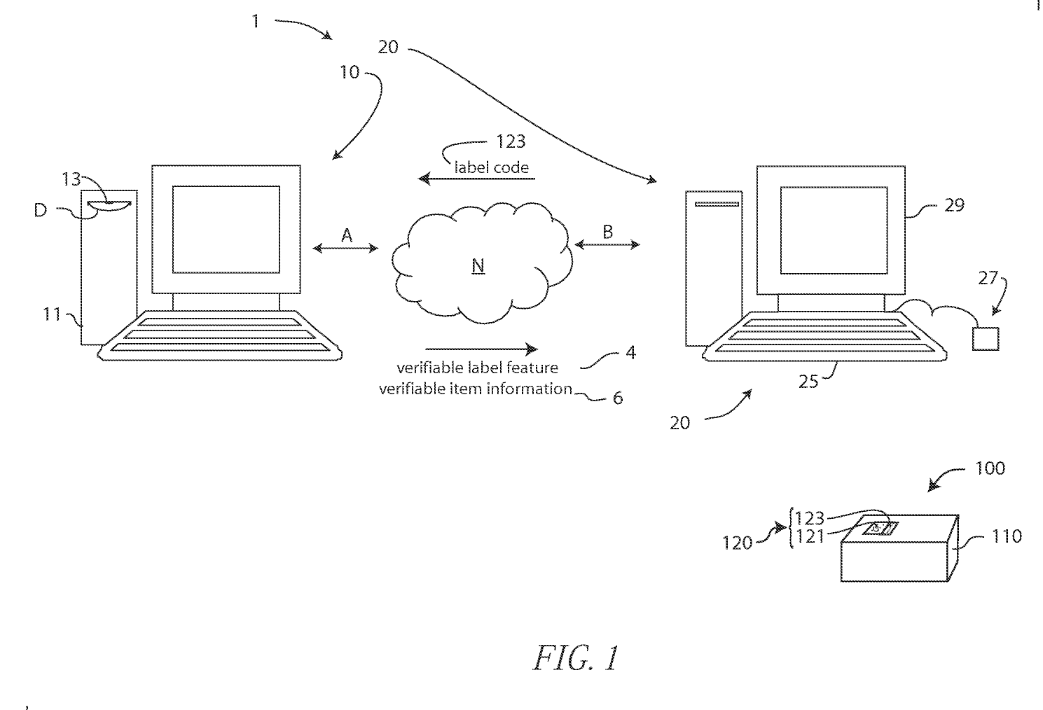

FIG. 1 is a schematic of one embodiment of a verification system 1 that may be used to verify the authenticity of labeled items. The authentic items include, but are not limited to, manufactured goods for purchase or use by consumers, distributors, manufacturers, or medical personnel. Verification system 1 may be used, for example, at any time after the labeling of authentic items to confirm item authenticity. In addition, certain embodiments of system 1 allow for the assembly of information regarding items and their verification that has use in analyzing the dissemination and distribution of goods. In one embodiment, the manufacturer or distributor of items is charged a fee by an operator of verification system 1 to label items. Consumers of labeled items are then provided free access to the database to validate the authenticity of the items.

In the following discussion of FIG. 1 it is assumed, without limitation as to the scope of the present invention, that a consumer has in their possession an item having a label that may be verified using verification system 1. In one embodiment, each label includes a unique human or machine readable portion (a “label code”) and a unique visually identifiable portion (a “label feature”), and verification system 1 has access to a listing of each label code and associated label feature, which may be an image of the label feature. A consumer may send the label code to verification system 1. Verification system 1 determines which label feature image is associated with the label code, and provides an image of the label feature to the consumer. The consumer then compares the label feature on the labeled item with the image of the label feature provided by verification system 1 and may determine if the item is authentic. Alternatively, the listing of verification system 1 includes item information corresponding to each label code, and verification system also provides the consumer with item information to facilitation item verification.

System 1 includes a first computer 10 and a second computer 20. Computers 10 and 20 include a processor and memory which may also include, but are not limited to, keyboards such as keyboard 25, barcode readers, such as reader 27, mice, touch screens, or other input devices, and may also include a display 29 and a media reader 13.

Computers 10 and 20 are configured to communicate, as indicated by the arrows A and B over a network N. Network N may be, but is not limited to, a combination of one or more wired and/or wireless networks adapted to transmit information between computers and may be, without limitation, the Internet or any other communication system.

In one embodiment, computer 10 includes or is provided with information related to labels and associated authentic items, such as a label-item database. Thus, for example, computer 10 is supplied with a removable media D containing some or all of the information related to labels and associated authentic items. Removable media D may be, for example and without limitation, a readable or a read-write device capable of accessing information on a CD, DVD, or tape, or a removable memory device such as a Universal Serial Bus (USB) flash drive. In an alternative embodiment, computer 10 or obtains some or all of the information over network N from another computer (not shown). In another alternative embodiment, the functions of computers 10, 20 and network N are provided in a single computer (not shown).

While not necessarily a part of System 1, FIG. 1 also shows one example of a labeled item 100. Labeled item 100 includes an item 110 and a label 120. In one embodiment which is not meant to limit the scope of the invention, label 120 includes two parts: a label feature 121 and a label code 123. In one embodiment, all or part of the label is manufactured and is then affixed to the item, where the affixing includes, but is not limited to adhesively applying some or all of the label to the item and/or to an item wrapper. In another embodiment, all or part of the label is incorporated into or onto the item—such as through a printing process.

In the phrases “labeling an item,” or “affixing a label to an item” or its equivalent, as used herein, it is to be understood that the label may attached to the actual item, either directly or through an other object that is affixed to the item including, but not limited to, an item label, or to another object which contains the item including, but not limited to, an item's package.

Label code 123 may include, for example and without limitation, one or more of a human-readable code and a machine readable code. The human readable code may be, but is not limited to, one or more alphanumeric characters. The machine readable code may be, but is not limited to, an optical, magnetic, or electrically readable code. Alternatively, the machine readable code and human readable code may be physically the same—thus for example, alphanumeric characters of a human-readable code may be scanned into a computer, which then recognizes the characters and generates an electronic representation of the human-readable code. In one embodiment, for example, the characters of an alphanumeric label code 123 are entered into computer 20 through keyboard 25 or a barcode is entered into computer 20 through reader 27.

Label feature 121 is intended to be a part of the label that is not be easily associated with label code 123. Thus, for example, and without limitation, label feature 121 may be randomly or pseudo randomly assigned to label. In one embodiment, label feature 121 is a part of label 100 that is not easily reproduced. For example, and without limitation, label feature 121 may include, but is not limited to, a random pattern, image or human readable code; a three-dimensional structure embedded in the label; a hologram; one or more colors; or covering that renders photocopying difficult, such as a semi-reflective layer. In one embodiment, label feature 121 is scanned and converted into a computer presentable image file for later verification when label 120 is produced or, alternatively, when item 110 is labeled with label 100.

In one embodiment of a method of verifying labeled items, a user inputs label code 123 into computer 20, which transmits a digital representation of label code 123 through network N to computer 10. Computer 20 has access to a listing of authentic items and corresponding label information including, but not limited to, label codes (such as label code 123) and corresponding verifiable label features 4 and item information 6. The listing may be in a single, label-item database, or may be distributed among two or more databases or listings in one or more computers or readable media.

Verifiable label features 4 may be, for example, a previously scanned and stored image of label feature 121. Alternately, verifiable label feature 4 may be a textual description for comparison with label feature 121. Verifiable item information 6 may include, but is not limited to, an item name, description, characteristic, manufacturer, or distributor. Examples of verifiable item information 6 include, but are not limited to, one or more of: the item's manufacturer, model, weight or dosage of a contained substance, distributor, intended use, intended geographic local, or any other specific or general information related to the item or procurement or distribution thereof.

Verifiable label feature 4 and item information 6 are then displayed on display 29. A user may then compare verifiable label feature 4 with label feature 121 and product information 6 with item 110, and verify the authenticity of the labeled item. In an alternative embodiment, one or the other of verifiable label feature 4 and item information 6 are displayed on display 29. A user may then compare the displayed information with label feature 121 or item 110 and verify the authenticity of the labeled item.

Alternatively, label feature 121 is readable by reader 27 for conversion into a code corresponding to the feature. The code corresponding to label feature 121 and the code corresponding to label code 123 are stored on computer 10, and the verification can be performed, for example and without limitation, by computer 10, which transmits an indication of the verification to computer 20.

In an alternative embodiment, the label-item database is accessible to users and/or manufacturers via hard copy, radio, facsimile, or other electronic means, to verify the authenticity and origin of the item according to label code 123 and label feature 121 and/or product information 6.

In one embodiment, the manufacturer controls the veracity of the information submitted to the label-item database. An item without a unique identifier, such as label feature 121 will most likely not be a genuine product.

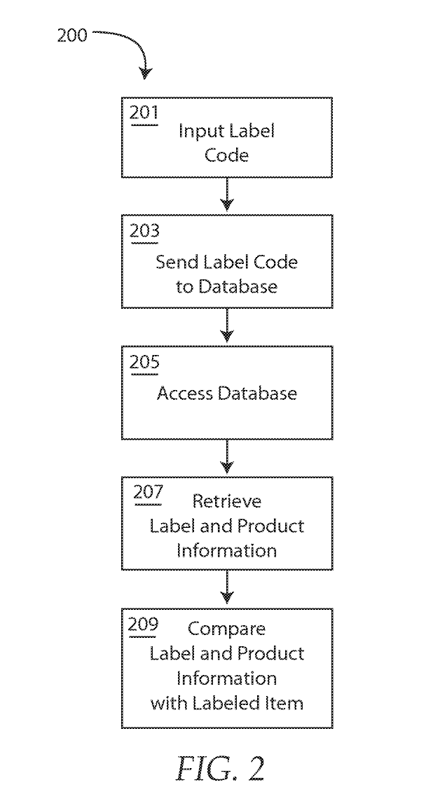

FIG. 2 is a flowchart illustrating one embodiment of a method 200 of using system 1 for verifying items. In one embodiment of method 200, which is not meant to limit the scope of the present invention, system 1 is illustratively illustrated as verifying labeled item 100 of FIG. 1. First, a label code is input into system 1 (Block 201). Thus, for example, label code 123 is entered into computer 20 through keyboard 25 or reader 27. Next, the label code is sent to a label-item database (Block 203). Thus, for example, computer 20 generates a digital representation of label code 123 and transmits the label code, through network N, to computer 10.

Next, a label-item database is accessed (Block 205). In one embodiment, computer 10 has, or has access to, a label-item database. In Block 205 label code 123 is used to determine corresponding verifiable label feature 4 and verifiable item information 6. Next, label and item information are retrieved (Block 207). Thus, for example, computer system 20 accepts label code 123 and returns, through network N and to computer system 10, verifiable label features 4 and verifiable item information 6 corresponding to label code 123.

In a last step, label and item information are compared with the labeled item (Block 209). Thus, for example, Computer system 20 retrieves and displays, on display 29, verifiable label features 4 and verifiable item information 6 from computer 10. Verifiable label feature 4 is then compared with label feature 121 and verifiable item information 6 is compared with item 110. If verifiable label feature 4 matches with label feature 121 and item information 6 matches with item 110, then item 110 may be considered to be an authentic item.

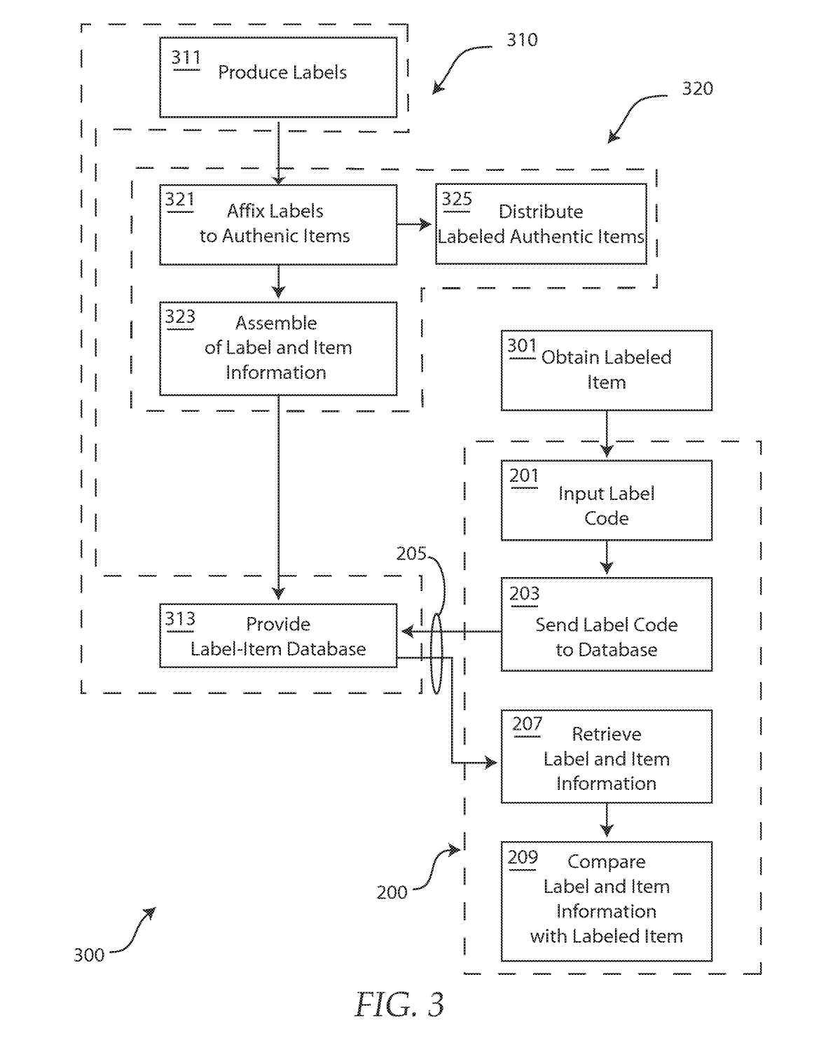

FIG. 3 is a flowchart of another embodiment of a method 300 for verifying products. Except as further detailed below, the embodiment of method 300 depicted in FIG. 2 may be generally similar to method 200 disclosed above.

Method 300 includes the steps of producing labels (Block 311), providing label and item information database for look-up in a label-item database (Block 313), affixing the labels to authentic items (Block 321), assembling label and authentic item information (Block 323), and distributing labeled authentic items (Block 325). FIG. 3 also shows Blocks 311 and 313 grouped together in a labeling service 310, and Blocks 321, 323, and 325 grouped together in an authentic item labeling and distribution service 320.

In one embodiment, the following method is used to produce labels (Block 311). First a number of codes are generated and stored in a database. The codes are being human readable and may be consecutive, random, or pseudo-random. The codes may be, for example and without limitation, label code 123, and include both a human readable and machine readable representation of the code. Next, label code 123 is printed on a label material having a label feature including but not limited to label feature 501. The label feature is then optically read, as by a charged coupled device or other image recorder, and information from the optically read label identifier is stored in the database and associated with the code. When the label having the code and label feature is associated with a product, the product information may be added to the database.

The stored code and image information from Block 311, combined with the item information from Block 323, provides the label-item database of Block 313.

As an illustrative example of method 300, a labeled item is obtained (Block 301), and is verified. In one embodiment, the steps of method 200 are then performed to verify the authenticity of the labeled item.

As shown in FIG. 3, access to the label-item database is controlled by labeling service 310. Labeling service 310 and authentic item labeling and distribution service 320 may be performed by one or more entities, such as business entities. Thus, in one embodiment, the steps of labeling service 310 are provided by a first business entity, and the steps of authentic item labeling and distribution service 320 are provided by a second business entity. In alternative embodiments, the methods of Blocks 311, 313, 321, 323, and 325 are performed by one or more related or unrelated business entities. In another embodiment, the service of Block 310 is provided to two or more services that distribute products.

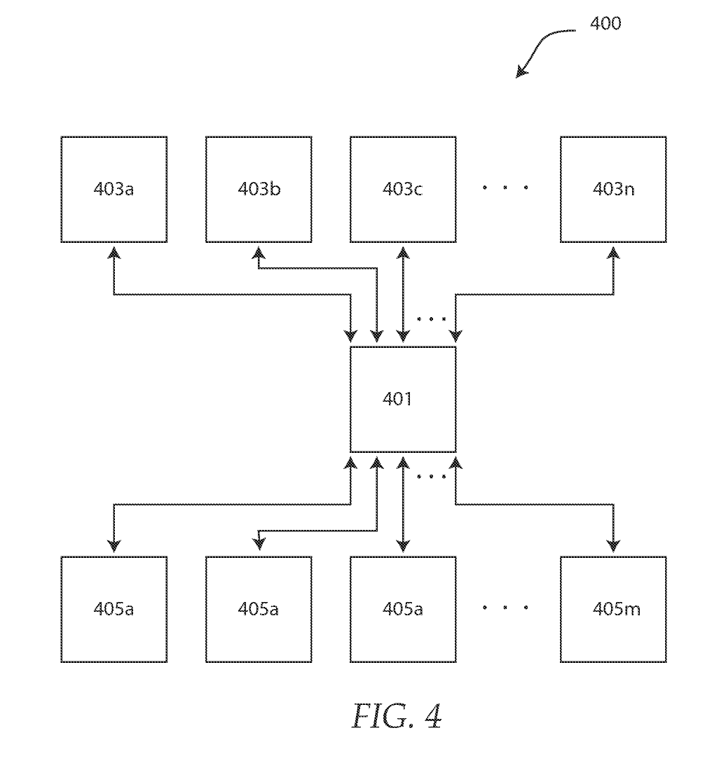

FIG. 4 is a block diagram illustrating another embodiment of a method 400 of verifying items. In method 400, labeling service 401, which may be for example and without limitation labeling service 310, provides labels and label-item database access for a plurality of item manufacturers or distributors 403, shown as distributors 403a, 403b, 403c, . . . , 403n. In one embodiment of method 400, for example, labeling service 401 performs the methods of Blocks 311 and 313 for each distributor 403. Thus, each distributor 403 receives labels from labeling service 401, and affixes the labels, compiles label-item information, and distributes the labeled authentic items, as indicated, for example, in Block 320.

A receiver of labeled items 405, shown as receivers 405a, 405b, 405c, . . . , 405m, may then contact labeling service 401 to authenticate labeled items, as shown, for example, in Block 200. In one embodiment, distributors 403 pay labeling service 401 for labels and for receivers to verify items. Fees may be based on the number of labels provided, the amount of access to the label-item database, or some other consideration.

In an alternative embodiment, labeling service 310 or 401 maintains a log of the receivers of labeled items 110 or 405 and assembles customer information that is useful for the distributors or other entities in the distribution chain. Thus, for example, system 1 or 400 permits the creation of a voluntary and specific list of clients from the voluntary registration or verification of the information on the service servers. Such lists have a value as direct marketing tool for the manufacturer. In one embodiment, the information is used to provide the receivers with information such as the availability of similar consumer oriented goods. Thus, for example, when a person verifies an item over the Internet, the person could be directed to a link that may possibly be of interest to the user, such as a link to other similar products or a manufacturer's website.

### Label Embodiments

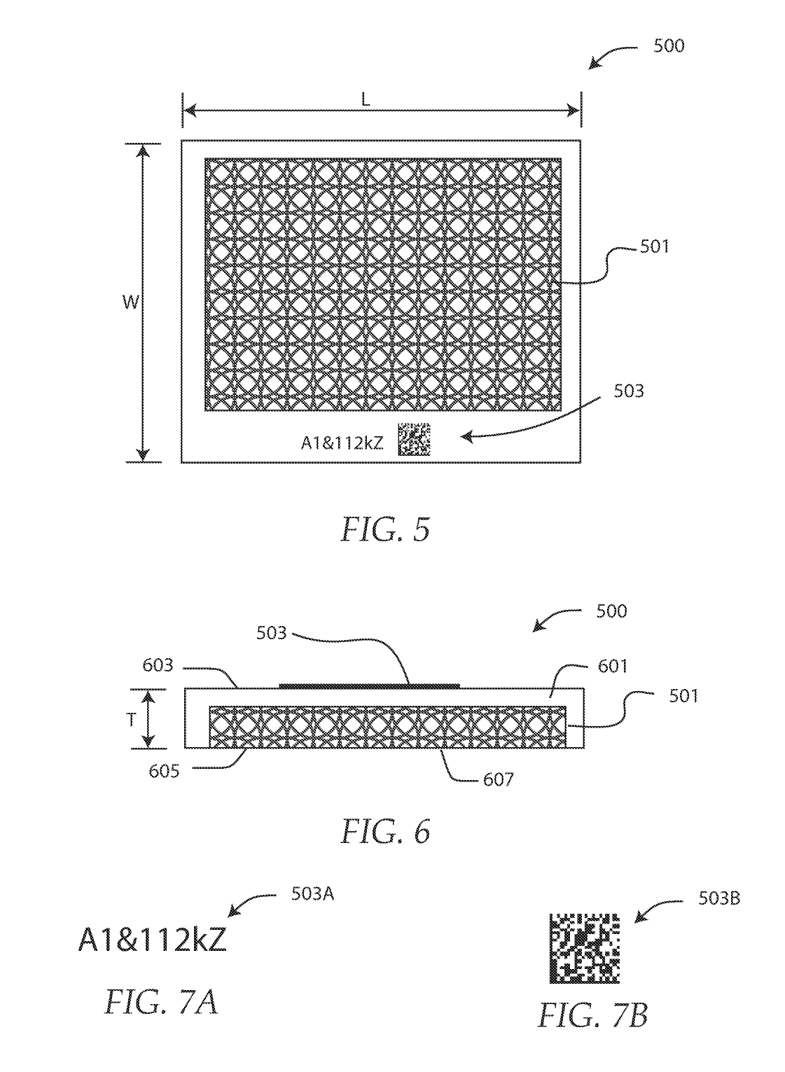

FIG. 5 is a top view of one embodiment of a label 500 and FIG. 6 is a side view of the label of FIG. 5, showing label 500 as including a label material 601, and having a top surface 603, a bottom surface 605, and an adhesive 607. Label material 601 contains and/or provides support for a combination of markings and/or structures that are indicated, in general and without limitation, as a label feature 501 and a label code 503. Except as further detailed below, label 500 may be generally similar to label 120, label feature 501 may be generally similar to label feature 121, and label code 503 may be generally similar to label code 123.

In one embodiment, label code 501 is affixed or printed on top surface 603, and label feature is embedded within or is partially surrounded by label material 601. Adhesive 607 preferably renders label 500 difficult to remove once affixed to a surface, which may be, for example, the surface of an item. As described subsequently, the label feature 501 and label code 503 are incorporated into or onto the label material 601, and are visible through top surface 603. Label code 503 is shown for illustrative purposes, and without limitation, as including both a human-readable alphanumeric string and a machine readable two-dimensional barcode, as described subsequently.

Also shown in FIGS. 1 and 2 are the thickness T, width W and length L of label 500. In one embodiment, W ranges range from 4 mm to 90 mm, and L ranging from 4 mm to 90 mm. The thickness T is chosen to accommodate label feature 501 and label code 503, and may be, for example between the range of 0.1 mm to 30 mm n one embodiment, T is from approximately 1 mm to approximately 30 mm.

In one embodiment, label 500 has a release layer (not shown) for protecting adhesive 607 prior to use. In another embodiment, the label 500 does not include an adhesive 607, but is affixed to a product by providing a transparent adhesive sheet applied over the top surface 603 and label code 503 when affixing label 500 to a surface. In yet another alternative embodiment, label feature 501 and label code 503 are provided on separate labels that are either attached to each other prior to being affixed to a surface, or which are affixed separately to the same surface of an item.

In certain embodiments, each label 500 includes a unique label feature 501 and a corresponding unique label code 503. Each label 500 thus provides means for uniquely identifying the label, and thus any item to which it is affixed.

FIGS. 7A and 7B are top views of a first label code 503A and a second label code 503B, respectively. FIG. 7A shows label code 503A as having human readable code forming an alphanumeric indicator. It is preferred that the alphanumeric characters are easily readable and that they conform to character sets that may be input to a computer. FIG. 7B shows an label code 503B as a machine-readable code. Label 500 may include any machine-readable code that can be incorporated into or onto label 500, or that can be provided along with a label feature 501. While label code 503B is shown as being a two-dimensional barcode, specifically a Datamatrix code, the invention is not limited to any specific machine readable code. In an alternative embodiment, label code 503 includes both a human readable code and machine-readable markings.

In general, label feature 501 may be formed within label material 601, or on top surface 603 or bottom surface 605. In one embodiment, label feature 501 is formed using a process that generates a random pattern that is not easily reproducible. Thus, for example, in one embodiment label feature 501 is formed as the result of an additive process such as deposing randomly shaped opaque particles on a transparent label material 601. In another embodiment, label feature 501 is formed by a subtractive process, such as first coating a transparent label material 601 with an opaque coating and then removing the opaque coating in a random manner. The adding or removing of material to create a unique, three-dimensional label which, due to the random generation process, cannot be easily duplicated.

In one embodiment, label feature 501 has some visual quality, identifiable to a person, which makes it difficult to reproduce label feature by photocopying, for example, label 500 may have a three-dimensional structure. It is also preferred that some general features of label feature 501 are reproducible, for example a frontal view of the label feature. Thus, for example, label feature 501 formed of three-dimensional filaments protruding into the depth of label 500 would have distinct visual qualities. An image of label feature 501 could be formed on paper or as an image for display on a computer screen, but would lack the three-dimensional quality of the original label 500. A reproduced image of label feature 501 would supply a person with sufficient information to identify the general features of the label feature, and the three-dimensional aspect of the image would permit authentication of label 500.

Methods of forming the label features 501 include, but are not limited to: electrostatically depositing, spraying, or randomly depositing plastic, organic, metallic, magnetic or not, or mineral materials; or a subtractive process, where, for example, a uniform layer of a material is first placed on a label adhesive layer, and then the material is randomly removed from the label as, for example, by scraping, adhesively removing, or chemically reacting with a solvent.

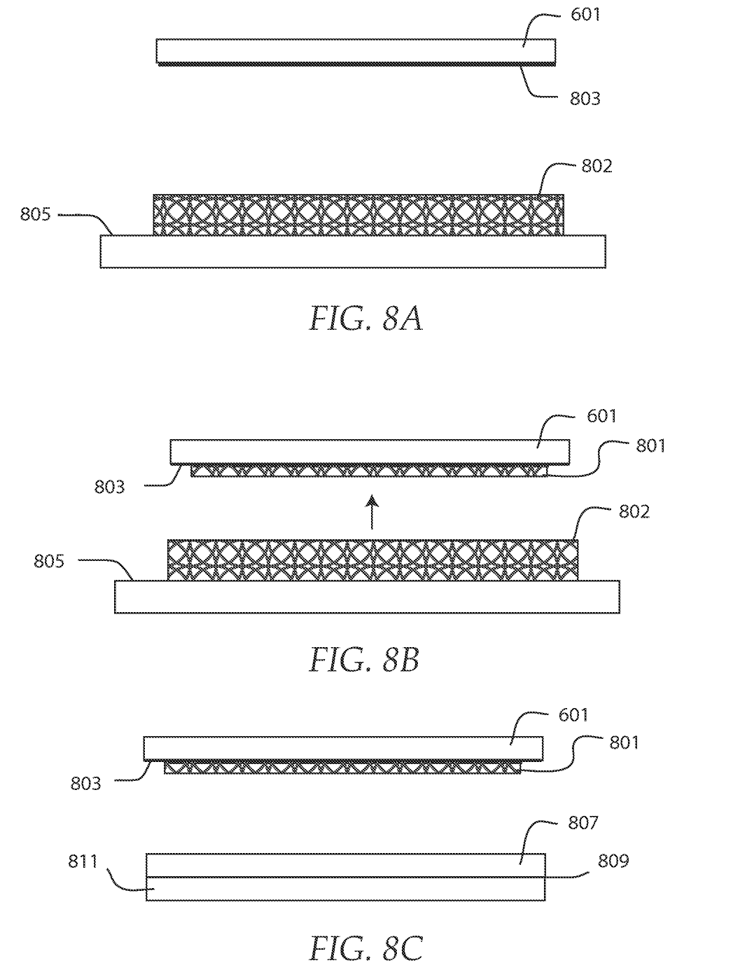

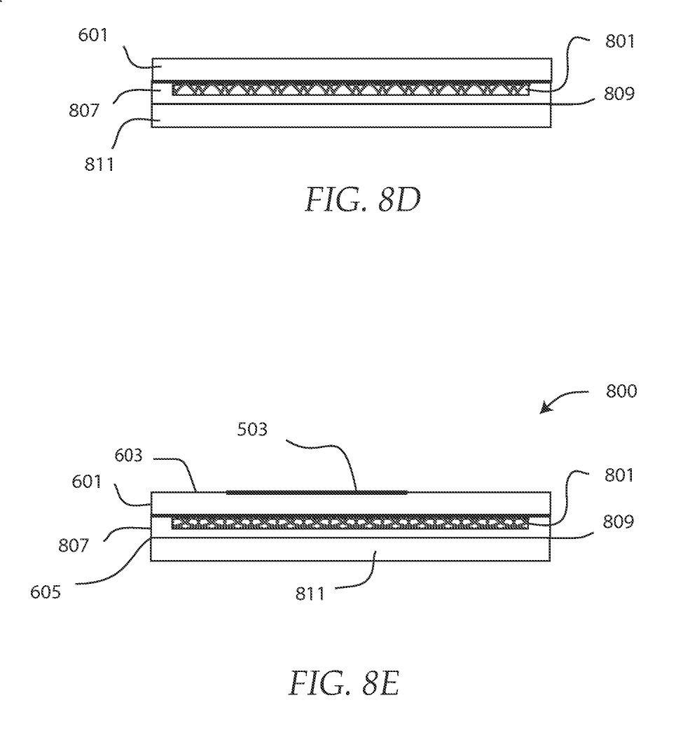

FIGS. 8A-8E are side views of one embodiment of a manufacturing process of an embodiment of label 800, where FIG. 8A is a first step, FIG. 8B is a second step, FIG. 8C is a third step, FIG. 8D is a fourth step, and FIG. 8E is a fifth step. Label 800 may be generally similar to label 120 or 500, except as further detailed below.

As shown in FIG. 8A, a label material 601 having an adhesive 803 is placed over a tray 805 having a feature material 802. Feature material 802 includes, but is not limited to, filaments or elongated pieces that preferably can be electrostatically charged. Thus, for example, the feature material 802 include, but are not limited to lint, such as a magnetic material, copper, cotton or wool lint, or pieces of iron or plastic. Feature material 802 is preferably thick enough and long enough to be detected visually, and kinked or bent enough to form visually perceptible three-dimensional patterns. It is also preferred, though not necessary, for feature material 802 to include randomly shaped material.

As shown in FIG. 8B, feature material 802 and label material 601 are electrostatically charged with opposite polarity and are brought near one another. The attraction of feature material 802 to adhesive layer 803 results in a random, three-dimensional label feature 801 that is adhered to label material 601. Label feature 801 is generally similar to label feature 501 or 121, except as further detailed below.

Next, in FIG. 8C, tray 805 is moved away from label material 601, and a plastic film 807 having an adhesive 809 and a protective removable release layer 811 is brought near label feature 801. As shown in FIG. 8D, plastic film 807 is placed over label feature 801. This action covers label feature 801, protecting the unique, three-dimensional label feature from tampering or from normal usage.

Finally, as shown in FIG. 8E, label code 503 is printed on top surface 603, forming label 800 having removable release layer 811.

In alternative embodiments, feature material 801 is affixed to an adhesive on top surface 605, and a clear plastic film (not shown) is placed over the top of label 800.

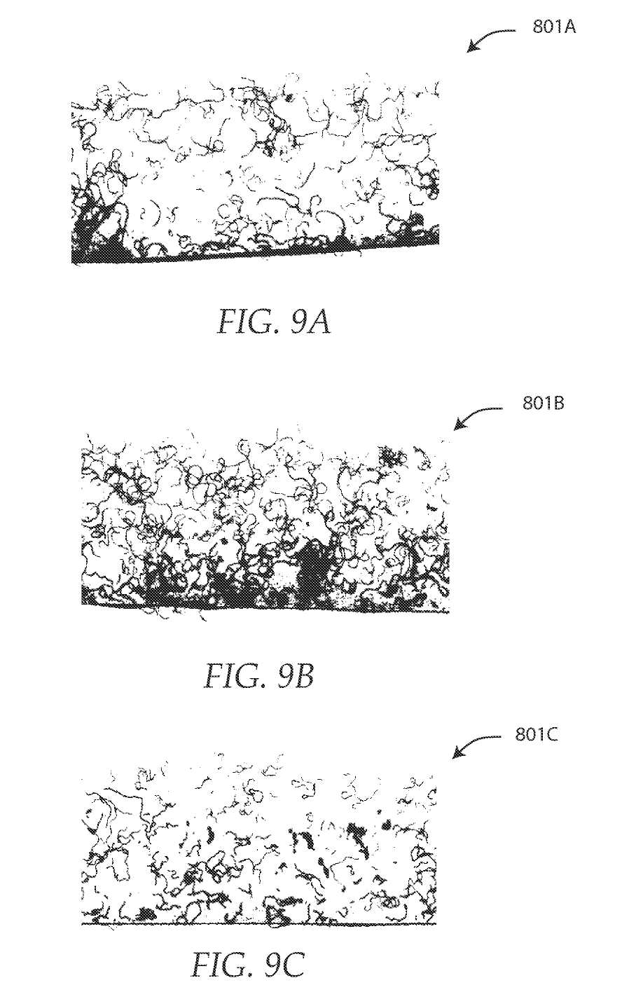

FIGS. 9A-9C are schematic illustrations of top views different label features 801, formed by three different applications of the steps of FIGS. 8A to 8D, where FIG. 9A is a top view of a first label feature 801A, FIG. 9B is a top view of a second label feature 801B, and FIG. 9C is a top view of a third label feature 801C. FIGS. 9A-9C show that the electrostatic attraction of random particles generates patterns that are visually different.

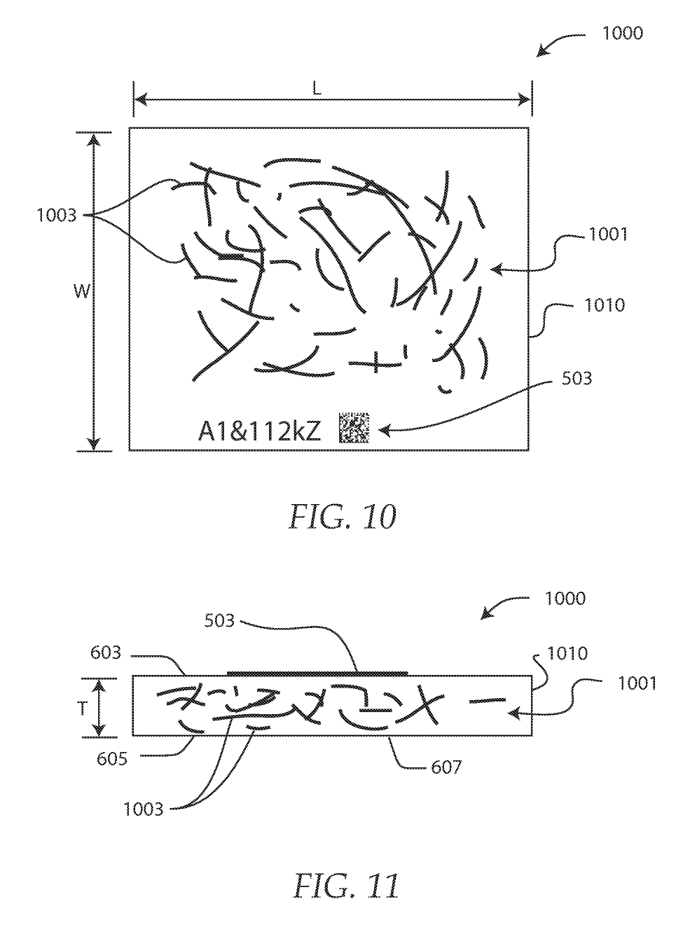

FIG. 10 is a top view and FIG. 11 is a side view of a second embodiment of a label 1000. Label 1000 includes a label material 1010 that supports a label feature 1001. Except as further detailed below, label 1000 may be generally similar to label 120, 500, or 800, label feature 1001 may be generally similar to label feature 121 or 501, and label material 1010 may be generally similar to label material 601.

Label material 1010 is generally transparent and capable of supporting a plurality of elements 1003 that are randomly embedded within label material. The plurality of elements 1003 form label feature 1001. In general, the plurality of elements 1003 is oriented within material 1010.

In one embodiment, label material 1010 is a clear substrate, including but not limited to urethane, and the plurality of elements 1003 are beads suspended in the clear substrate. Material 1010 thickness range from 0.1 mm to 30 mm, and elements 1003 are randomly distributed the material. One method of making label feature 1001 is to insert randomly visible particles in a clear substrate such as plastic or glass.

Alternative materials for the plurality of elements 1003 include, but are not limited to, a material with either regular or irregular shape, and can include, but are not limited to, the materials described above which form label feature 121 or 501, including but not limited to, glass or plastic. In another alternative embodiment, the material of elements 1003 is magnetic.

Reference throughout this specification to “one embodiment,” “an embodiment,” or “certain embodiments” means that a particular feature, structure or characteristic described in connection with the embodiment is included in at least one embodiment of the present invention. Thus, appearances of the phrases “in one embodiment,” “in an embodiment,” or “in certain embodiments” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Although certain preferred embodiments and examples are disclosed herein, it will be understood by those skilled in the art that the inventive subject matter extends beyond the specifically disclosed embodiments to other alternative embodiments and/or uses of the invention, and to obvious modifications and equivalents thereof. Thus it is intended that the scope of the inventions herein disclosed should not be limited by the particular disclosed embodiments described below. Thus, for example, in any method or process disclosed herein, the acts or operations making up the method/process may be performed in any suitable sequence, and are not necessarily limited to any particular disclosed sequence. For purposes of contrasting various embodiments with the prior art, certain aspects and advantages of these embodiments are described where appropriate herein. Of course, it is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

Thus, while there has been described what is believed to be the preferred embodiments, those skilled in the art will recognize that other and further modifications may be made thereto without departing from the spirit of the invention, and it is intended to claim all such changes and modifications as fall within the scope of the invention.

1. A method of item verification comprising:
providing two or more labels each having unique label information.

2. The method of claim 1, where said label information includes a code and a feature.

3. The method of claim 1, further comprising charging for the service of providing said two or more labels.

4. The method of claim 2, further comprising:
storing label information and item information associated with each label.

5. The method of claim 4, further comprising:
accepting an item code; and
providing stored item information associated with said item code.

6. The method of claim 5, further comprising not charging for said accepting an item code or providing stored item information.

7. The method of claim 5, where said accepting includes accepting over a computer network, and where said providing includes providing over a computer network.

8. The method of claim 4, further comprising:
accepting an item code; and
providing stored label feature information associated with said item code.

9. The method of claim 8, where said label feature information is an image of said label feature.

10. The method of claim 8, where said accepting includes accepting over a computer network, and where said providing includes providing over a computer network.

11. The method of claim 2, where said code is a human-readable code including one or more alphanumeric characters.

12. The method of claim 2, where said code is a machine-readable code.

13. The method of claim 12, where said machine-readable code is a bar code.

14. (canceled)

15. The method of claim 2, where said label includes an at least partially transparent material, and where said feature includes a three-dimensional feature within said at least partially transparent material.

16. The method of claim 2, where said label includes an at least partially transparent material, and where said feature includes one or more objects within said label.

17. The method of claim 16, where at least one of said one or more objects is a filament.

18. The method of claim 16, where at least one of said one or more objects is a bead.

19. The method of claim 1, where said label includes a semi-reflective layer covering at least a portion of said information.

20. A method of providing item verification services for items associated with one of a plurality of labels, where each of said plurality of labels includes a label code and a label feature, said method comprising:
accepting a code corresponding to the label code of one of the plurality of labels, where said code has associated information; and
providing at least a portion of said associated information.

21. The method of claim 20, where said accepting includes accepting over a computer network.

22. The method of claim 20, where said code is a human-readable code including one or more alphanumeric characters.

23. The method of claim 20, where said code is a machine-readable code.

24. The method of claim 23, where said machine-readable code is a bar code.

25. The method of claim 20, where said providing includes providing over a computer network.

26. The method of claim 20, where said associated information includes information related to said label feature.

27. The method of claim 26, where said information related to said label feature is an image of at least part of said label feature.

28. The method of claim 20, where said associated information includes information related to the item associated with said code, and further comprising providing information related to said associated item.

29. The method of claim 28, where said information related to said associated item is a description of at least part of said associated item.

30. The method of claim 28, where said information related to said associated item is an image of at least part of said associated item.

31. An apparatus to facilitate verification of items associated with one of a plurality of labels, where each of said plurality of labels includes a label code and a label feature, said apparatus including a device to:
accept a code corresponding to the label code of one of the plurality of labels, where the accepted code has associated information; and
provide said associated information.

32. The apparatus of claim 31, where said code is accepted over a computer network.

33. The apparatus of claim 31, where said code is a human-readable code including one or more alphanumeric characters.

34. The apparatus of claim 31, where said code is a machine-readable code.

35. The apparatus of claim 34, where said machine-readable code is a bar code.

36. The apparatus of claim 31, where said associated information is provided over a computer network.

37. The apparatus of claim 31, where said associated information includes information related to a label feature.

38. The apparatus of claim 37, where said information related to said label feature is an image of at least part of said label feature.

39. The apparatus of claim 31, where said associated information includes information related to the item associated with said code, and where said associated information includes information related to said associated item.

40. The apparatus of claim 39, where said information related to said associated item is a description of at least part of said associated item.

41. The apparatus of claim 39, where said information related to said associated item is an image of at least part of said associated item.

42. A label having a top and a bottom, said label comprising a feature visible through the top, where said feature includes randomly distributed three-dimensional elements.

43. The label of claim 42, where said elements include one or more of a magnetic element, a non-magnetic element, a mineral element, or an organic element.

44. The label of claim 42, where said elements are visible to the human eye.

45. The label of claim 42, where the thickness of the label is between 0.1 mm and 30 mm.

46. The label of claim 42, further comprising a code corresponding to said randomly distributed three-dimensional elements, where said code is visible through the top.

47. The label of claim 46, where said code includes one or more alphanumeric characters.

48. The label of claim 46, where said code includes a machine-readable code.

49. The label of claim 47, where said code further includes a machine-readable code.

50. The label of claim 42, where said label further comprises a base having top and a bottom, where said elements are disposed on said top of said base, and where said bottom of said base forms at least a portion of the bottom of said label.

51. The label of claim 49, where said bottom of said base includes an adhesive.
